(19) United States
(12) Patent Application Publication
(10) Pub. No.: US 2014/0365073 A1
(43) Pub. Date: Dec. 11, 2014

(54) SYSTEM AND METHOD OF COMMUNICATING WITH VEHICLE PASSENGERS

(71) Applicant: FORD GLOBAL TECHNOLOGIES, LLC, Dearborn, MI (US)

(72) Inventors: Joseph F. Stanek, Northville, MI (US); Siamak Hashemi, Farmington Hills, MI (US); Ramy Boctor, Canton, MI (US); John A. Lockwood, Canton, MI (US); Lisa Scott, Northville, MI (US)

(21) Appl. No.: 13/910,303

(22) Filed: Jun. 5, 2013

(51) Int. Cl. B60R 16/02

(52) U.S. Cl. CPC B60R 16/02
USPC 701/36

(57) ABSTRACT

One embodiment of an on-vehicle audio system may include at least one of a transceiver and a plug connector configured to communicatively connect to a mobile phone. The transceiver or plug connector may receive a voice signal generated by a microphone device integrated in the mobile phone. Further, the system may also include an on-board controller configured to receive an audio signal from an audio source and the voice signal from the transceiver or plug connector. The controller may be configured to interrupt the audio signal and output the voice signal on an on-board speaker.

### BACKGROUND

Communication between a driver and vehicle passengers can be somewhat cumbersome, particularly if the vehicle has multiple rows of seats and at least some of the passengers are located in the seats farthest from the driver. In addition, vehicles having various entertainment systems including DVD players, stereos and video game consoles may further distract passengers from a driver attempting to communicate with them.

Vehicle intercom systems are well known. Larger passenger vehicles, such as limousines, may have intercom systems that facilitate communication between the driver and the passengers. However, the intercom systems may be separate from vehicle sound and entertainment systems, such as stereos or video players, which may still need to be independently and manually shut off or have their volume lowered in order for the passengers to hear the driver. Moreover, the additional equipment represented by the intercom system may increase the cost of the vehicle and add to its weight, thereby decreasing fuel economy.

Vehicles having navigation systems are well known. These navigation systems may be integrated with vehicle stereos to announce driving directions while temporarily attenuating or lowering the volume of a then existing media broadcast. These systems typically are limited to announcing turn-by-turn directions. However, these systems may not actually be used to assist the driver in communicating with distracted occupants.

It would therefore be desirable to provide a system and method for communicating with vehicle passengers that can use common components of vehicle systems to reduce cost of the vehicle while facilitating communication with passengers and alerting a driver of approaching road conditions.

### SUMMARY

One embodiment of an on-vehicle audio system may include a transceiver or a plug connector configured to communicatively connect to a mobile phone. The transceiver or plug connector may receive a voice signal generated by a microphone device integrated in the mobile phone. Further, the system may also include an on-board controller configured to receive an audio signal from an audio source, as well as the voice signal from the transceiver or plug connector. The controller may be configured to interrupt the audio signal and output the voice signal on an on-board speaker.

One embodiment of a method of broadcasting audio within a vehicle may include receiving an audio signal from an audio source and further receiving a voice signal from a microphone device integrated within a mobile phone. The method may further include the step of interrupting the audio signal to output the voice signal on an on-vehicle speaker.

### BRIEF DESCRIPTION OF THE FIGURES

FIG. 1 is a conceptual illustration of one embodiment of an on-vehicle audio system for facilitating communication between a driver and passengers of a vehicle;

FIG. 2 is a flowchart illustrating exemplary steps in a method to operate the system of FIG. 1 and facilitate communication between a driver and passengers of a vehicle; and

FIG. 3 is a flowchart illustrating exemplary steps in a method to operate the system of FIG. 1 and alert vehicle occupants of various road conditions and provide other notifications.

### DETAILED DESCRIPTION

One embodiment of an on-vehicle audio system may permit a driver to communicate in real-time with passengers through on-board speakers and one or more various media player devices, while suspending the existing media that had been broadcasting on speaker or devices or lowering the volume of those speakers and devices. The system may be configured to receive voice signals received from and generated by a microphone device that is installed on a mobile phone. In this respect, the rapid development of phone applications and easy updates to programs on mobile phones may permit a driver to communicate with passengers in various ways or provide various information to all vehicle occupants. Of course, in another embodiment, the system may instead use a microphone device of an on-vehicle communications system to allow for further use of common parts and reduce costs associated therewith.

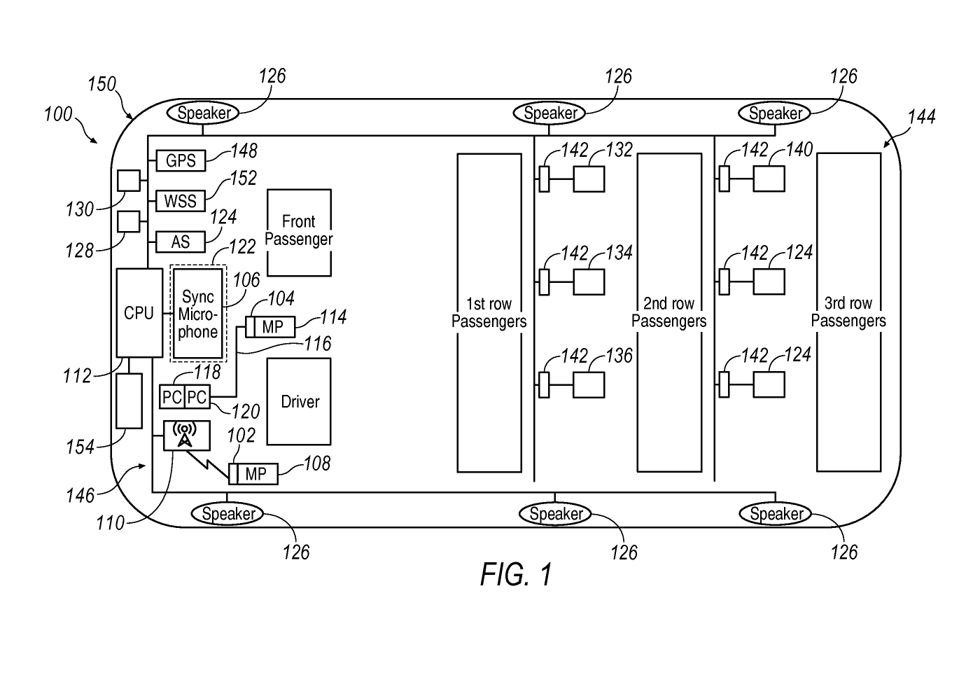

FIG. 1 illustrates a conceptual illustration of one embodiment of an on-vehicle audio system 100 (“audio system”) for a vehicle 150 to improve communication from a driver to passengers within a vehicle cabin 156 and providing information related to approaching driving conditions. This information may include announcements or messaging directed to, for example, estimated time of arrival, current vehicle location or an upcoming maneuver or stop. The audio system 100, in this form, may include one or more microphone devices 102, 104, 106 that generate a voice signal in response to an oral statement spoken into the microphone 102, 104, 106 by a vehicle occupant, such as the driver.

As one example, the microphone device 102 may be a portable microphone device that is an integral portion of a mobile phone 108, and the audio system 100 may further include an on-board transceiver 110 that communicatively connects the mobile phone 108 to an on-board controller 112, discussed in detail below. In this respect, the on-board transceiver 110 may provide a wireless connection between the microphone device 102 and the controller 112 by, for example, BLUETOOTH wireless hardware. However, the transceiver 110 may include and be communicatively connected with wireless connection hardware produced or licensed by any suitable manufacturer.

Another microphone device 104 may also be a portable microphone device that is an integral portion of a mobile phone 114, and may include a cord 116 or line terminating at one end with a plug connector 118. The audio system 100 may further include a plug connector 120, such as a jack or female connector, configured to receive the plug connector 118 of the cord 116 so as to communicatively connect the microphone device 104 of the mobile phone 114 to the controller 112.

By still another example, the microphone device 106 may be an on-board microphone device that is a component of an on-vehicle communications system 122, such as a SYNC communication system. The microphone device 106 may be a component of the system itself or a separate component used in conjunction with the audio system 100.

The audio system 100 may further include an audio source 124, which generates an audio signal, and one or more on-board speakers 126 receiving the audio signal to output audio based on the audio signal. As one example, the audio source 124 may be a radio tuner 128 that receives a radio signal and broadcasts a radio program on the speakers 126. Other examples of audio sources may include various media player devices, such as a CD player 130, a DVD player 132 or other on-board media players. The audio sources 124 may also include mobile devices, such as a tablet computer 134, a portable handheld media player 136, a personal digital assistant 138, another mobile phone 140 or other suitable media player devices. Of course, the audio sources may be integral components of the audio system 100 or be separate audio sources communicatively connected to the audio system 100.

The controller 112 may be communicatively connected to the audio sources 124 by the transceiver 110. Further, the controller may also be communicatively connected to the audio sources 124 by plug connectors 142 arranged throughout the vehicle cabin 144 and an on-vehicle circuit 146 in connection between the plug connectors 142 and the controller 112. The controller 112 may be configured to receive the audio signal generated by the audio sources 124 and may transmit the audio signal to the speakers 126 to broadcast audio on the speakers 126 based on the audio signal. Continuing a previous example, if the audio source 124 is a radio tuner, the controller 112 may transmit the radio signal received from the selected radio station to the speakers so as to output or broadcast the radio program on the speakers 126.

The controller 112 may be further communicatively connected to any one or more of the microphone devices 102, 104, 106 to receive the respective voice signals therefrom, and interrupt the audio signal so as to broadcast or output the voice signal on the speakers 126, in response to receiving the voice signal. As with the previous example, the controller 112 may interrupt playing a radio program on the speakers 126 to instead broadcast an occupant's statement made into any of the microphone devices 102, 104, 106. In this respect, the speakers 126 may be configured to receive the voice signal or the audio signal and output audio based on the voice signal.

The audio system 100 may be further configured to interrupt the audio signal to output a notification signal. Examples of notification signals may include an algorithm-generated driving instruction, a vehicle location, a traffic condition, a driving condition, other notifications or any combination of this information.

As one example, the audio system 100 may be configured to provide audio alerts indicative of driving and road conditions or other alerts. To that end, one embodiment of the audio system 100 may include a GPS receiver 148 generating a GPS signal indicative of a current location of the vehicle 150. The audio system 100 may further have a wheel speed sensor 152 generating a speed signal indicative of a current speed of the vehicle 150. Further, the audio system 100 may have an electronic storage device 154 including a lookup table indicative of a plurality of reference notification signals based on the speed of the vehicle and a current road condition associated with the location of the vehicle, as indicated by the speed and GPS signals, respectively. This table may include empirical data based on collected performance characteristics of the vehicle, in view of its center of gravity, curbside weight, lateral acceleration and numerous other performance metrics. By one example, for a given vehicle, the empirical data may indicate an optimum method of operating the vehicle in response to detecting the current speed of the vehicle toward a bend in the road having a radius of curvature, as indicated by the speed and GPS signals. Furthermore, another embodiment of the audio system may include forward horizon looking algorithms stored on a computer readable medium and implement other elements disclosed herein to announce crash avoidance situations and measures taken by the vehicle.

The audio system 100 may further be used as a public address system by, for example, an individual opening the vehicle doors and windows when the vehicle is parked and then speaking into any one or more of the microphone devices 102, 104, 106. The applications of this public address system may include requesting emergency assistance, providing entertainment or various other conditions in which amplification of an individual's voice may be beneficial. Furthermore, the audio system 100 may be used for other applications requiring the use of one or multiple microphones.

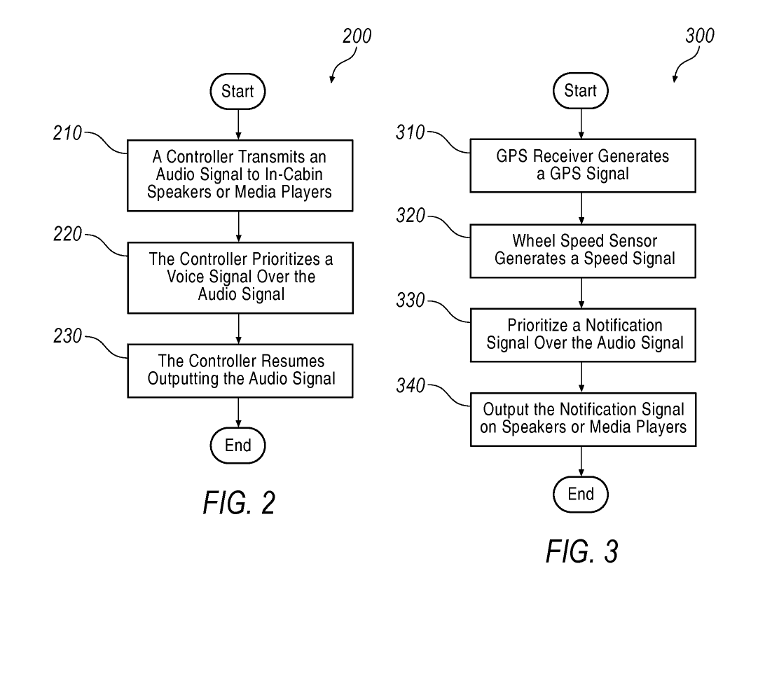

FIG. 2 illustrates a flowchart for one embodiment of a method 200 of operating the system 100 to communicate with other occupants of the vehicle cabin through on-board speakers or various media players in the vehicle cabin 156. At step 210, an audio source 124 may generate an audio signal and transmit the audio signal to the controller, which in turn transmits the audio signal to one or more on-vehicle speakers 126 or media players in the cabin, so as to output or broadcast audio within the vehicle based on the audio signal. For example, the audio source may be an on-board radio tuner receiving a radio broadcast signal via an antenna and transmit the radio broadcast signal to the speakers to output a radio program on the speakers. This step may be accomplished by using various audio sources, such as an on-board CD player, a DVD player, a portable media player, a mobile phone or other audio sources.

At step 220, a microphone may generate a voice signal in response to an oral statement spoken into the microphone, and transmit the voice signal to the controller 112. Further, the controller may in turn interrupt the audio signal and transmit the voice signal to the speakers 126 or media players to output the oral statement in the vehicle cabin based on the voice signal. Examples of media players include the tablet computer 134, the portable handheld media player 136, the personal digital assistant 138, another mobile phone 140 or other media player devices. In one embodiment, the driver may communicate with passengers seated in the rearmost location of a vehicle by speaking into the microphone 102 integrated in the mobile phone 108, which in turn generates the voice signal based on the oral statement and wirelessly transmits the voice signal to the controller via the on-vehicle transceiver 110. The transceiver 110 may transmit the voice signal to the controller 112, which may then be communicatively connected to the speakers 126 or other media players to interrupt the radio broadcast signal to suspend outputting the radio program on the speakers and transmit the voice signal to the speakers and media players for broadcasting the oral statement. This step may instead be accomplished by using the microphone 104 on the mobile phone 114 communicatively connected to the controller 112 by a hard wire connection 116 through the plug connector 120. Alternatively, this step may be accomplished by using the on-board microphone 106 or other microphones communicatively coupled to the controller 112. In one embodiment, the driver may activate the microphone by actuating a button or other switch. However, the microphone may be activated by other suitable methods. Continuing a previous example, this step may be accomplished using one or multiple microphones with the vehicle doors and windows in open positions to provide an announcement to the exterior vehicle surroundings when, for example, the vehicle is parked.

At step 230, the controller 112 may resume outputting the audio from the audio signal in response to the driver or other vehicle occupant completing the oral statement. This step may be accomplished by the driver actuating the button or other switch or an algorithm that may be stored on the storage device 154 and configured to detect completion of the oral statement.

FIG. 3 illustrates a flowchart for another embodiment of a method 300 of operating the system 100 of FIG. 1, which may provide audio alerts indicative of driving and road conditions and other alerts through on-vehicle speakers 126 and various media players within the cabin 156. At step 310, the GPS receiver may generate the GPS signal indicative of a location of the vehicle 150 and transmit the GPS signal to the controller 112.

At step 320, the wheel speed sensor 152 may generate the speed signal indicative of the speed of the vehicle 150 and transmit the speed signal to the controller 112.

At step 330, the controller 112 may prioritize an alert or other notification signal higher than the audio signal to interrupt the audio signal and output the notification signal or voice signal on one or more on-vehicle speakers 126 and media players. For example, this step may be accomplished by the controller 112 accessing the electronic storage device 154 to determine a notification signal or alert based on the GPS signal and the speed signal. In particular, the controller may access a lookup table stored on the storage device 154, and the lookup table may provide of multiple reference notification signals based on corresponding vehicle speeds and road conditions associated with the location of the vehicle. For example, the lookup table may include a notification signal indicating that the vehicle is approaching a sharp turn or other road condition at a speed higher than a predetermined threshold speed for the vehicle, based on the current speed of the vehicle and approaching road condition as indicated by the GPS signal and/or speed signal. This may be beneficial when visibility is poor in, for example, foggy conditions on unlighted roadways. Alternatively, this step may increase awareness of road conditions if the driver is distracted. In particular, the audio system may execute suitable forward looking algorithms stored on a computer readable medium to determine the alert or notification signal of higher priority than the audio signal.

At step 340, the controller 112 may communicatively connect with the speakers 126 or other media players, interrupt audio on the speakers or other media players and broadcast the alert based on the notification signal on one or more of the speakers and media players. Continuing the previous example, the controller 112 may determine that the vehicle 150 is traveling faster than a predetermined speed based on the notification signal and transmit the signal to the speakers 126 or other media players in the vehicle 150, which may in turn notify the driver and occupants of the vehicle traveling at a speed above a predetermined threshold for the approaching road condition, such as a sharp curve in the road. Of course, the method may be configured to generate other sensor signals and determine various other notification signals stored on the storage device for alerting vehicle occupants.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An on-vehicle audio system, comprising:
at least one of a transceiver and a plug connector configured to communicatively connect to a mobile phone and receive a voice signal generated by a microphone device integrated in the mobile phone; and
an on-board controller configured to receive an audio signal from an audio source and the voice signal;
wherein the controller is configured to interrupt the audio signal and output the voice signal on an on-board speaker.

2. The on-vehicle audio system of claim 1, wherein the speaker is configured to receive the voice signal and the audio signal and output audio based on one of the voice signal and the audio signal.

3. The on-vehicle audio system of claim 1, further comprising a transceiver configured to communicatively connect the controller to the mobile phone by a wireless connection.

4. The on-vehicle audio system of claim 1, further comprising an on-vehicle circuit in connection between the plug connector and the controller.

5. The on-vehicle audio system of claim 1, wherein the audio source may include at least one mobile media player, and further comprising a transceiver configured to communicatively connect the controller to the at least one mobile media player to transmit the voice signal to the at least one mobile media player and interrupt the audio signal to output the voice signal on the at least one mobile media player.

6. The on-vehicle audio system of claim 5, wherein the at least one mobile media player is at least one of a tablet computer, a personal digital assistant and another mobile phone.

7. The on-vehicle audio system of claim 1, further comprising a GPS receiver generating a GPS signal indicative of a current location of the vehicle.

8. The on-vehicle audio system of claim 7, wherein the controller is coupled to the GPS receiver to generate a notification signal based on the GPS signal.

9. The on-vehicle audio system of claim 8, wherein the controller prioritizes the signals to interrupt the audio signal to output one of the voice signal and the notification signal.

10. The on-vehicle audio system of claim 7, further comprising a wheel speed sensor generating a speed signal indicative of a current speed of the vehicle.

11. The on-vehicle audio system of claim 10, wherein the controller is coupled to the wheel speed sensor to generate a notification signal based on the speed signal.

12. The on-vehicle audio system of claim 8, wherein the notification signal is indicative of at least one of a driving instruction, a vehicle location, a traffic condition and a driving condition.

13. The on-vehicle audio system of claim 10, further comprising an electronic storage device storing a lookup table indicative of a plurality of reference notification signals based on the current speed and the current location of the vehicle.

14. An on-vehicle audio system, comprising:
at least one of a transceiver and a plug connector configured to communicatively connect to at least one of a portable microphone device integrated in a mobile phone and an on-board microphone device and receive a voice signal generated by at least one of the portable microphone device and the on-board microphone device; and
an on-board controller configured to receive an audio signal from an audio source and further receive the voice signal;
wherein the controller is configured to interrupt the audio signal and output the voice signal on an on-board speaker.

15. A method of broadcasting audio within a vehicle, comprising:
receiving an audio signal from an audio source and a voice signal from a microphone device integrated within a mobile phone;
prioritizing the signals to interrupt the audio signal to output the voice signal on at least one on-vehicle speaker.

16. The method of claim 15, further comprising receiving the voice signal and the audio signal and outputting audio for one of the voice signal and the audio signal.

17. The method of claim 15, further comprising communicatively connecting a controller to at least one media player device to output the voice signal on the at least one media player device, which includes at least one of a tablet computer, an on-board media player, a portable media player, a personal digital assistant and another mobile phone.

18. The method of claim 15, further comprising:
generating a GPS signal indicative of a current location of the vehicle;
generating a notification signal based on the GPS signal; and
interrupting the audio signal to output one of the voice signal and the notification signal on an on-board speaker.

19. The method of claim 18, further comprising:
generating a speed signal indicative of a current speed of the vehicle; and
generating the notification signal further based on the speed signal.

20. The method of claim 19, wherein outputting the notification signal comprises accessing a lookup table stored on an electronic storage device and determining the notification signal based on at least one of the GPS signal and the speed signal.
